(19) United States
(12) Patent Application Publication
(10) Pub. No.: US 2024/0160935 A1
(43) Pub. Date: May 16, 2024

(54) METHOD AND A SYSTEM FOR GENERATING A DIGITAL TASK LABEL BY MACHINE LEARNING ALGORITHM

(71) Applicant: Direct Cursus Technology L.L.C, Dubai (AE)

(72) Inventors: Nikita PAVLICHENKO, Moscow (RU); Boris TSEYTLIN, Korolyev (RU); Dmitry USTALOV, Saint Petersburg (RU)

(21) Appl. No.: 18/386,597

(22) Filed: Nov. 2, 2023

(30) Foreign Application Priority Data
Nov. 10, 2022 (RU) 2022129234

(51) Int. Cl. G06N 3/084

(52) U.S. Cl. CPC G06N 3/084

(57) ABSTRACT

A method system for selecting a label for a task, the method including, at a training phase: acquiring, a digital training task; acquiring, by the server, a plurality of digital training task labels having been submitted by a plurality of workers; acquiring, a worker activity history associated with each of the worker; training the MLA, including: inputting, the digital training task into the MLA; inputting, the worker activity histories into the MLA; generating a triplet of training objects, the triplet of training object including: the task vector representation, a given worker vector representation and a given digital training task label associated with the given worker vector representation; using the triplet of training objects to train the MLA to predict a given digital task label for a given digital task's task vector representation and a given worker vector representation.

### CROSS-REFERENCE

The present application claims priority to Russian Patent Application No. 2022129234, entitled “Method and a System for Generating a Digital Task Label by Machine Learning Algorithm”, filed Nov. 10, 2022, the entirety of which is incorporated herein by reference.

### FIELD

The present technology relates to methods and systems for generating a digital task label, and more particularly methods and systems for generating a digital task label for a digital task in a crowdsourced environment.

### BACKGROUND

Machine learning algorithms require a large amount of labelled data for training. Crowdsourced platforms, such as the Amazon Mechanical Turk™, make it possible to obtain large data sets of labels in a shorter time, as well as at a lower cost, compared to that needed for a limited number of experts.

However, it is known that assessors typically available on the crowdsourced platforms are generally non-professional and vary in levels of expertise, and therefore the obtained labels are much noisier than those obtained from experts.

United States Patent Application Publication No. 2020/0327582 A1 published Oct. 15, 2020, to Yandex Europe AG and titled “Method and System for Determining Result for Task Executed in Crowd-Sourced Environment”, discloses a method and system for determining a result for a task executed in a crowdsourced environment. The method comprises receiving, a plurality of results of the task having been submitted by a plurality of human assessors; receiving a quality score for each human assessor of the plurality of human assessors; generating a plurality of vector representations comprising a vector representation for each of the results; mapping, the plurality of vector representations into a vector space; clustering the plurality of vector representations into at least a first cluster and a second cluster; executing a machine learning algorithm configured to generate a first confidence parameter and a second confidence parameter; in response to a given one of the first confidence parameter and the second confidence parameter meeting a predetermined condition, generating, an aggregated vector representation; and selecting the aggregated vector representation as the result of the task.

United States Patent Application Publication No. 2021/0133606 A1 published May 6, 2021, to Yandex Europe AG, and titled “Method and System for Selecting Label from Plurality of Labels for Task in Crowd-Sourced Environment”, discloses a method and system for selecting a label for a task, the method comprising: receiving a plurality of labels, each of the label included within the plurality of labels being indicative of a given assessor's perceived preference of a first object of over a second object; analyzing the comparison task to determine a set of latent biasing features; executing a MLA configured to generating a respective latent score parameter for the first object and the second object, the respective latent score parameter indicative of a probable offset between the given assessor's perceived preference and an unbiased preference parameter of the first object over the second object; generating a predicted bias degree parameter for the given assessor; generating the unbiased preference parameter; using, by the server, the unbiased preference parameter as the label for the comparison task for the given assessor.

### SUMMARY

It is an object of the present technology to provide improved method and systems for generating a digital task label.

Without wishing to be bound to any specific theory, embodiments of the present technology have been developed based on an assumption that if properly trained, a machine learning algorithm can properly mimic the label selection process executed by expert assessors, or assessors with a high-quality rate in selecting correct labels.

In accordance with a first broad aspect of the present technology, there is provided a computer-implemented method for generating a digital task label by a machine learning algorithm (MLA), the method being executable by a server communicatively coupled to a crowdsourced digital platform, the method comprising: at a training phase: acquiring, by the server, a digital training task to be executed on the crowdsourced digital platform; acquiring, by the server, a plurality of digital training task labels responsive to the digital training task having been submitted by a plurality of workers of the crowdsourced digital platform, a given digital training label having been submitted by a given worker in response to a given digital training task using the crowdsourced digital platform; acquiring, by the server, a worker activity history associated with each of the worker from the plurality of workers, the worker activity history including previously submitted digital task labels by each of the worker; training, by the server, the MLA, the training including: inputting, by the server, the digital training task into the MLA, the MLA being configured to generate a task vector representation corresponding to a vectorial representation of the digital training task; inputting, by the server, the worker activity histories into the MLA, the MLA being configured to generate a respective worker vector representation corresponding to a vectorial representation of a given worker activity history for a given worker from the plurality of workers; generating a triplet of training objects, the triplet of training object including: the task vector representation, a given worker vector representation and a given digital training task label associated with the given worker vector representation; using the triplet of training objects to train the MLA to predict a given digital task label for a given digital task's task vector representation and a given worker vector representation; at an in-use phase: acquiring, by the server, the given digital task; determining, by the server, the given digital task's task vector representation; predicting, using the MLA, a plurality of digital task labels to the given digital task, based on a set of worker vector representations and the given digital task's task vector representation; determining, by the server, the digital task label corresponding to at least one digital task label of the plurality of digital task labels to the given digital task.

In some non-limiting embodiments of the method, determining the digital task label comprises executing a majority vote of the plurality of digital task labels to the given digital task.

In some non-limiting embodiments of the method, the method further comprises determining for each of the worker of the plurality of workers, a respective quality score corresponding to a previous success rate in providing correct digital task labels, the previous success rate being determined based on the respective worker activity history.

In some non-limiting embodiments of the method, the set of worker vector representations comprises a subset of the plurality of workers meeting a predetermined condition.

In some non-limiting embodiments of the method, the predetermined condition corresponds to the subset of the plurality of workers comprising one or more workers having a previous success rate above a predetermined threshold.

In some non-limiting embodiments of the method, the given digital task is a first type of digital task, and the predetermined condition corresponds to the subset of the plurality of workers comprising one or more workers having a previous success rate above a predetermined threshold for the first type of digital task.

In some non-limiting embodiments of the method, generating the worker vector representation for the given worker comprises: determining, for the given worker, a latent parameter indicative of a degree of bias of the given worker towards one or more latent features included within the digital training task, the latent parameter being determined by an analysis of a confusion matrix associated with the given worker; generating the worker representation based on the latent parameter.

In some non-limiting embodiments of the method, generating the task vector representation of the training digital task comprises: determining, for the training digital task, one or more latent features affecting the selection of the given training label by the given worker; generating the task vector representation based on the one or more latent features.

In some non-limiting embodiments of the method, the one or more latent features include at least one of: a font size associated with the content of the training digital task; an image size associated with the content of the training digital task; a number of possible selectable labels associated with the training digital task; a location of the possible selectable labels within the content of the training digital task.

In accordance with a second broad aspect of the present technology, there is provided a system for generating a digital task label by a machine learning algorithm (MLA), the system comprising a server communicatively coupled to a crowdsourced digital platform, the server comprising a processor configured to: at a training phase: acquire, a digital training task to be executed on the crowdsourced digital platform; acquire, a plurality of digital training task labels responsive to the digital training task having been submitted by a plurality of workers of the crowdsourced digital platform, a given digital training label having been submitted by a given worker in response to a given digital training task using the crowdsourced digital platform; acquire, a worker activity history associated with each of the worker from the plurality of workers, the worker activity history including previously submitted digital task labels by each of the worker; train, the MLA, to train the MLA, the processor being configured to: input, the digital training task into the MLA, the MLA being configured to generate a task vector representation corresponding to a vectorial representation of the digital training task; input, the worker activity histories into the MLA, the MLA being configured to generate a respective worker vector representation corresponding to a vectorial representation of a given worker activity history for a given worker from the plurality of workers; generate a triplet of training objects, the triplet of training object including: the task vector representation, a given worker vector representation and a given digital training task label associated with the given worker vector representation; use the triplet of training objects to train the MLA to predict a given digital task label for a given digital task's task vector representation and a given worker vector representation; at an in-use phase: acquire, the given digital task; determine, the given digital task's task vector representation; predict, by executing the MLA, a plurality of digital task labels to the given digital task, based on a set of worker vector representations and the given digital task's task vector representation; determine, the digital task label corresponding to at least one digital task label of the plurality of digital task labels to the given digital task.

In some non-limiting embodiments of the system, to determine the digital task label, the processor is configured to execute a majority vote of the plurality of digital task labels to the given digital task.

In some non-limiting embodiments of the system, the processor is further configured to determine for each of the worker of the plurality of workers, a respective quality score corresponding to a previous success rate in providing correct digital task labels, the previous success rate being determined based on the respective worker activity history.

In some non-limiting embodiments of the system, the set of worker vector representations comprises a subset of the plurality of workers meeting a predetermined condition.

In some non-limiting embodiments of the system, the predetermined condition corresponds to the subset of the plurality of workers comprising one or more workers having a previous success rate above a predetermined threshold.

In some non-limiting embodiments of the system, the given digital task is a first type of digital task, and the predetermined condition corresponds to the subset of the plurality of workers comprising one or more workers having a previous success rate above a predetermined threshold for the first type of digital task.

In some non-limiting embodiments of the system, to generate the worker vector representation for the given worker, the processor is configured to: determine, for the given worker, a latent parameter indicative of a degree of bias of the given worker towards one or more latent features included within the digital training task, the latent parameter being determined by an analysis of a confusion matrix associated with the given worker; generate the worker representation based on the latent parameter.

In some non-limiting embodiments of the system, to generate the task vector representation of the training digital task, the processor is configured to: determine, for the training digital task, one or more latent features affecting the selection of the given training label by the given worker; generate the task vector representation based on the one or more latent features.

In some non-limiting embodiments of the system, the one or more latent features include at least one of: a font size associated with the content of the training digital task; an image size associated with the content of the training digital task; a number of possible selectable labels associated with the training digital task; a location of the possible selectable labels within the content of the training digital task.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a system implemented in accordance with non-limiting embodiments of the present technology.

FIG. 2 depicts a screen shot of a crowdsourced interface implemented in accordance with a non-limiting embodiment of the present technology, the interface being depicted as displayed on a screen of an electronic device of the system of FIG. 1.

FIG. 3 depicts an example of a process for training machine learning algorithm implemented in accordance with non-limiting embodiments of the present technology.

FIG. 4 depicts a schematic diagram of a process for determining a label for a digital task in a crowdsourced environment.

FIG. 5 depicts a block diagram of a flow chart of a method for determining a label for a digital task in a crowdsourced environment.

### DETAILED DESCRIPTION

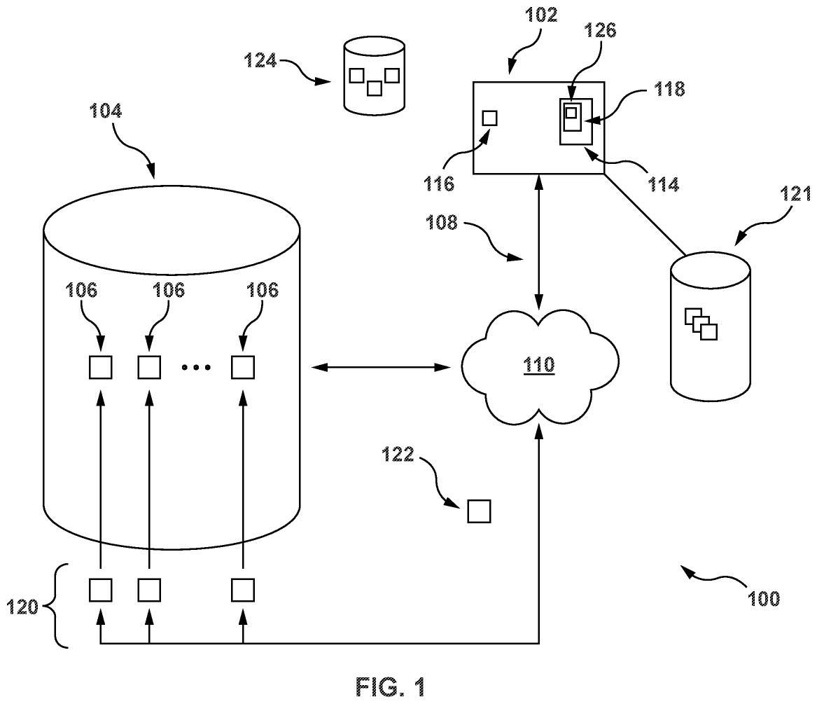

Referring to FIG. 1, there is shown a schematic diagram of a system 100, the system 100 being suitable for implementing non-limiting embodiments of the present technology. Thus, the system 100 is an example of a computer-implemented crowdsourced environment. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represents conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises a server 102 and a database 104 accessible by the server 102.

As schematically shown in FIG. 1, the database 104 comprises an indication of identities of a plurality of human assessors 106, who have indicated their availability for completing at least one type of a crowdsourced digital task and/or who have completed at least one crowdsourced digital task in the past and/or registered for completing at least one type of the crowdsourced digital task.

In some non-limiting embodiments of the present technology, the database 104 is under control and/or management of a provider of crowdsourced services, such as Yandex LLC of Lev Tolstoy Street, No. 16, Moscow, 119021, Russia. In alternative non-limiting embodiments of the present technology, the database 104 can be operated by a different entity.

The implementation of the database 104 is not particularly limited and, as such, the database 104 could be implemented using any suitable known technology, as long as the functionality described in this specification is provided for. In accordance with the non-limiting embodiments of the present technology, the database 104 comprises (or has access to) a communication interface (not depicted), for enabling two-way communication with a communication network 110.

In some non-limiting embodiments of the present technology, the communication network 110 can be implemented as the Internet. In other non-limiting embodiments of the present technology, the communication network 110 can be implemented differently, such as any wide-area communication network, local area communications network, a private communications network and the like.

It is contemplated that the database 104 can be stored at least in part at the server 102 and/or be managed at least in part by the server 102. In accordance with the non-limiting embodiments of the present technology, the database 104 comprises sufficient information associated with the identity of at least some of the plurality of human assessors 106 to allow an entity that has access to the database 104, such as the server 102, to assign and transmit one or more digital tasks to be completed by the one or more human assessors 106.

At any given time, the plurality of human assessors 106 may comprise a different number of human assessors 106, such as fifty human assessors 106, who are available to complete digital tasks. The plurality of human assessors 106 could include more or fewer human assessors 106.

The server 102 can be implemented as a conventional computer server. In an example of a non-limiting embodiment of the present technology, the server 102 can be implemented as a Dell™ PowerEdge™ Server running the Microsoft™ Windows Server™ operating system. Needless to say, the server 102 can be implemented in any other suitable hardware and/or software and/or firmware or a combination thereof. In the depicted non-limiting embodiment of the present technology, the server 102 is a single server. In alternative non-limiting embodiments of the present technology, the functionality of the server 102 may be distributed and may be implemented via multiple servers.

The server 102 comprises a communication interface (not depicted) for enabling two-way communication with the communication network 110 via a communication link 108.

How the communication link 108 is implemented is not particularly limited and depends on how the server 102 is implemented. For example, the communication link 108 can be implemented as a wireless communication link (such as, but not limited to, a 3G communications network link, a 4G communications network link, a Wireless Fidelity, or WiFi®, for short, Bluetooth®, or the like) or as a wired communication link (such as an Ethernet based connection).

It should be expressly understood that implementations of the server 102, the communication link 108 and the communication network 110 are provided for illustration purposes only. As such, those skilled in the art will easily appreciate other specific implementational details for the server 102, the communication link 108, and the communication network 110. As such, by no means the examples provided hereinabove are meant to limit the scope of the present technology.

The server 102 comprises a server memory 114, which comprises one or more storage media and generally stores computer-executable program instructions executable by a server processor 116. By way of example, the server memory 114 may be implemented as a tangible computer-readable storage medium including Read-Only Memory (ROM) and/or Random-Access Memory (RAM). The server memory 114 may also include one or more fixed storage devices in the form of, by way of example, hard disk drives (HDDs), solid-state drives (SSDs), and flash-memory cards.

In some non-limiting embodiments of the present technology, the server 102 can be operated by the same entity that operates the database 104. In alternative non-limiting embodiments of the present technology, the server 102 can be operated by an entity different from the one that operates the database 104.

In some non-limiting embodiments of the present technology, the server 102 is configured to execute a crowdsourcing application 118. For example, the crowdsourcing application 118 may be implemented as a crowdsourcing platform such as Toloka™ crowdsourcing platform, or other proprietary or commercial crowdsourcing platform.

To that end, the server 102 is communicatively coupled to a digital task database 121. In alternative non-limiting embodiments, the digital task database 121 may be communicatively coupled to the server 102 via the communication network 110. Although the digital task database 121 is illustrated schematically herein as a single entity, it is contemplated that the digital task database 121 may be configured in a distributed manner.

The digital task database 121 stored an indication of a plurality of digital tasks (not separately numbered), each digital task corresponding to a human intelligence task (also referred herein as HITs, or simply “tasks”) (not separately numbered).

How the digital task database 121 is populated with the plurality of digital tasks is not limited. Generally speaking, one or more digital task requesters (not shown) may submit one or more digital tasks to be stored in the digital task database 121. In some non-limiting embodiments of the present technology, the one or more digital task requesters may specify the type of assessors the digital task is destined to, and/or a budget to be allocated to each human assessor 106 providing a result.

In some non-limiting embodiments of the present technology, the digital task database is further configured to store a set of task features (not shown) associated with each digital task stored within the digital task database 121. For example, the set of task-specific features of a given digital task may include one or more of, but not limited to a task ID and one or more latent features associated with the given digital task. In the context of the present specification, the phrase “latent feature” may correspond to any feature associated with a given digital task that a given human assessor 106 may have a prejudice in favour of or against, which may affect the judgment of the given human assessor 106 when executing the digital task, but that are irrelevant to the quality of the choices provided within the digital task (i.e. to the assessment digital task at hand). In other words, the latent features are those features of the digital task that do not (or should not) have a direct correlation to the label assigned to one of the two choices in the digital task, but can nevertheless exert an effect on the human assessors 106 in their executions of the digital task (discussed in more details below).

How the set of latent features is generated is not limited. For example, the set of latent features may be generated by the operator of the crowdsourcing application 118, or automatically via the use of a machine learning algorithm, in response to the given digital task being submitted by a requester to the crowdsourcing application 118.

How the digital task is implemented is not limited. In some non-limiting embodiments of the present technology, the digital task database 121 includes digital tasks that are annotation digital tasks (also known as classification digital tasks).

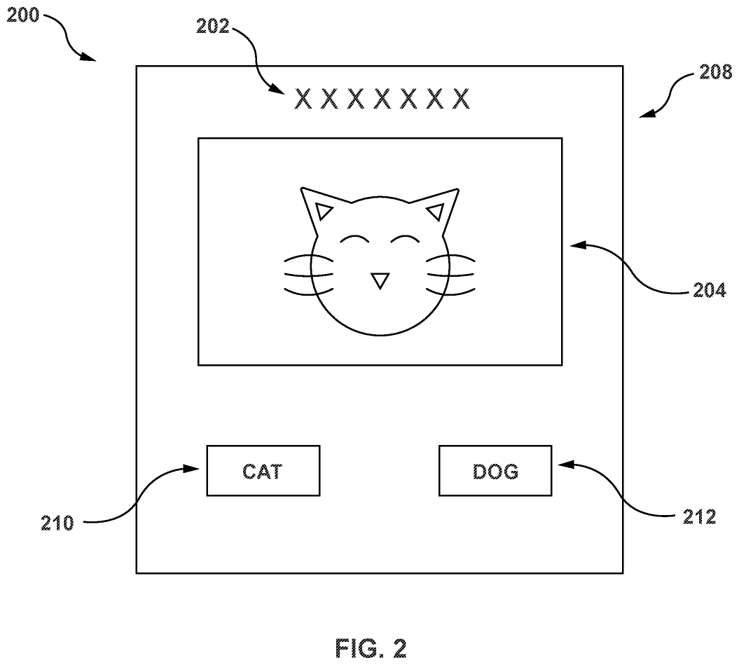

A classification digital task corresponds to a digital task in which the human assessors 106 are asked to select, via a label, a choice from at least a first category and a second category. With reference to FIG. 2, there is depicted a screen shot of a crowdsourced interface 200 implemented in accordance with a non-limiting embodiment of the present technology (the example of the interface 200 depicted as displayed on the screen of one of the electronic devices 120). The interface 200 illustrates an image classification digital task 208.

The interface 200 includes an instruction 202 to the human assessors 106, an object (i.e. an image 204). For the avoidance of any doubt, it should be mentioned that the text (and more specifically each letter) included within the interface 200 is represented by “X”, however, in reality the text is made up of words in a given language (such as in English). For example, the instruction 202 may comprise instructions to the human assessors 106 to choose the correct classification of the animal shown in the image 204. As such, the interface includes a first label 210 associated with the word “cat”, and a second label 212 associated with the word “dog”. Needless to say, other types of classification digital tasks are contemplated, such as the classification of documents, texts, and the like. Moreover, although only two labels are selectable within the digital task 208 (i.e. the first label 210 and second label 212), it should be understood that this is done for ease of explanation and it is contemplated that more than two labels be presented as selectable options.

The set of latent features may comprise, inter alia, visual and/or textual features associated with the digital task. Taking the digital task 208 as an example, the set of latent features may include one or more of, but not limited to:
A font size associated with the instruction 202 or other textual content within the interface 200;
A type of a digital task associated with the digital task 208 (such as categorization, translation, relevancy assessment, and the like);
Inherent complexity of the digital task 208, as assessed by an operator associated with the crowdsourcing application 118;
Demographic information of the human assessor 106;
A determination of the human assessor 106 having read the instruction 202, the determination being based on a response time to complete the digital task 208;
A size of the image 204; and
A number of possible selectable labels within the digital task 208 and their respective positions.

In some non-limiting embodiments of the present technology, the digital task database 121 also includes digital tasks that are non-classification digital tasks. For example, a non-classification digital task may comprise pairwise comparison digital tasks. A pairwise comparison corresponds to a digital task in which the human assessors 106 are asked to rank one or more objects (such as search engine result pages (SERPs), translations, etc.). In such instance, the set of latent features may additionally include, one or more of, but not limited to:
Morphological, syntactic and semantic relationships between lexemes included in the texts of the non-classification digital task;
Word and phrase coincidences included in the texts of the non-classification digital tasks; and
Contexts of words and verbose expressions of phrases included in the non-classification digital task.

Returning to FIG. 1, in accordance with the non-limiting embodiments of the present technology, the crowdsourcing application 118 is configured to assign a given digital task to at least a subset of the plurality of human assessors 106, which have indicated their availability in the database 104.

The server 102 is configured to communicate with various entities via the communication network 110. Examples of the various entities include the database 104, respective electronic devices 120 of the human assessors 106, and other devices that may be coupled to the communication network 110. Accordingly, the crowdsourcing application 118 is configured to retrieve the given digital task from the digital task database 121 and send the given digital task to a respective electronic device 120 used by the plurality of human assessors 106 to complete the given digital task, via the communication network 110 for example.

It is contemplated that any suitable file transfer technology and/or medium could be used for this purpose. It is also contemplated that the digital task could be submitted to the plurality of human assessors 106 via any other suitable method, such as by making the digital task remotely available to the plurality of human assessors 106.

In accordance with the non-limiting embodiments of the present technology, the server 102 is configured to receive a set of results (in the form of labels) of the digital task that has been completed by the plurality of human assessors 106. In accordance with the non-limiting embodiments of the present technology, the set of results could be received by the server 102 in one or more data packets 122 over the communication network 110 for example. It is contemplated that any other suitable data transfer means could be used.

Generally speaking, the crowdsourcing application 118 is configured to aggregate the set of results to determine a “true” label to the digital task at issue. For example, in response to the digital task 208, the crowdsourcing application 118 may receive, via the data packets 122, 200 “raw” labels (i.e. non-aggregated), each label selected by a respective human assessor 106. Generally, speaking, the crowdsourcing application 118 is configured to perform one or more aggregation methods to infer the true label from conflicting selected labels. The most basic aggregation model known in the field is the majority vote, under which the most frequent label for the digital task 208 is assumed to be the true label.

In some non-limiting embodiments of the present technology, the server 102 is further communicatively coupled to a log database 124 via a link (not numbered), which can be a dedicated link or the like. In alternative non-limiting embodiments of the present technology, the log database 124 may be communicatively coupled to the server 102 via the communication network 110, without departing from the teachings of the present technology. Although the log database 124 is illustrated schematically herein as a single entity, it is contemplated that the log database 124 may be configured in a distributed manner.

The log database 124 is configured to collect and store information associated with the human assessors 106 and the digital tasks that have been completed by the human assessors 106.

For example, the log database 124 may store worker activity histories, which comprises parameters and characteristics of the human assessors' 106 interactions with crowdsourcing application 118. More specifically, each worker activity history is associated with a specific human assessor 106. The worker activity history may include, but not limited to:
A time of registration of a given human assessor 106 with the crowdsourcing application 118;
A number of digital tasks completed by the given human assessor 106 since the time of registration and their respective completion time;
A number of completed digital tasks per hour;
The different types of digital tasks executed by the given human assessor 106 since the time of registration;
The task IDs of the digital task executed by the given human assessor 106 since the time of registration and the respective selected labels;
A quality score, or success rate of the given human assessor 106 corresponding to the reliability of a given result of a digital task completed by the given human assessor 106, or in other words, an error rate of the given human assessor.

How the quality score of the human assessor 106 is determined is not limited. For example, the quality score may be determined based on a first plurality of “honeypot tasks” completed by the given human assessor 106. In the present specification, the term “honeypot tasks” means a digital task the correct result of which is known prior to the digital task being submitted to the given human assessor 106 being tested/assessed for the quality score associated therewith, for completion thereof, which correct result is not provided to the given human assessor 106 being assessed.

In some non-limiting embodiments of the present technology, the quality score may also be determined (in addition to, or without honeypot tasks), based on an analysis of labels previously selected by the given human assessor 106 determined to be a true label for the respective digital task by the crowdsourcing application 118. It should be understood that the quality score may correspond to an overall quality score taking into account all previous completed digital tasks but may also include a type-specific quality score taking into account only previously completed digital tasks of a specific type.

Although the description of the system 100 has been made with reference to various hardware entities (such as the database 104, the server 102, the log database 124, the digital task database 121 and the like) depicted separately, it should be understood that this is done for ease of understanding. It is contemplated that the various functions executed by these various entities be executed by a single entity or be distributed among different entities.

In some non-limiting embodiments of the present technology, the crowdsourcing application 118 is configured to execute a machine learning algorithm (MLA) 126. In some non-limiting embodiments of the present technology, the MLA 126 is trained to execute a digital task (such as the digital task 208), without the need of the human assessors 106 (described in more detail below). In other words, taking the digital task 208 as an example, the MLA 126 is configured to select a label (such as the first label 210 and/or the second label 212) in response to receiving the digital task 208.

### MLA 126—Training Phase

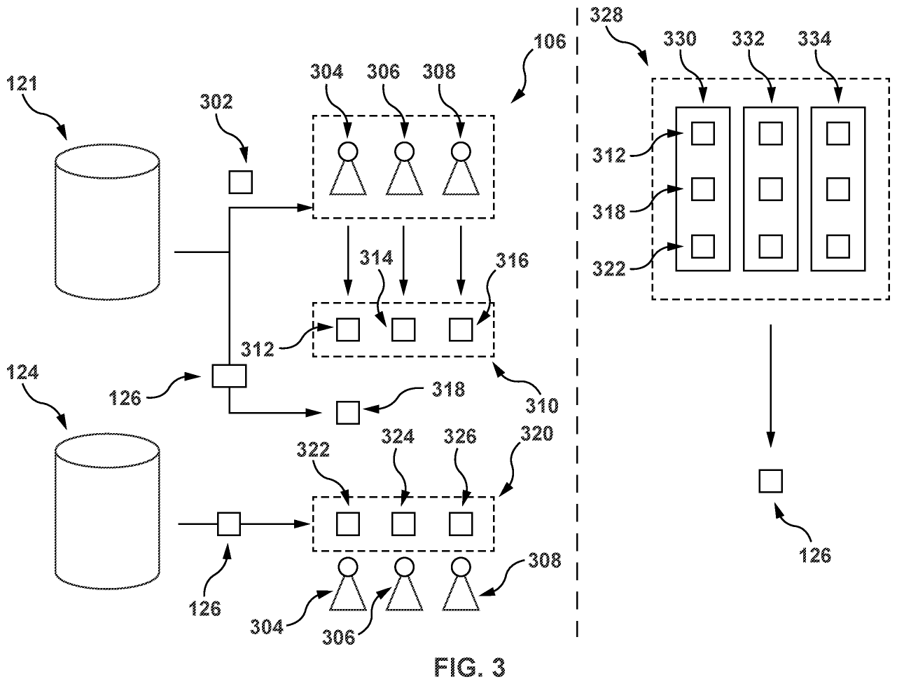

With reference to FIG. 3, a schematic illustration of a process of training the MLA 126 is depicted.

For a better understanding of the underlying concepts of the present technology, it should be understood that the training of the MLA 126 can be broadly separated into a first phase and a second phase. In the first phase, the training input data (discussed below) is generated. In the second phase, the MLA 126 is trained using the training input data. Moreover, although the steps of training the MLA 126 is explained as being executed by the processor 116, it is not limited as such. It should be understood that the training and/or the execution of the MLA 126 can be done by the server 102 and/or a different server communicatively coupled to the server 102.

How the training input data is generated will now be explained, which begins with the digital task database 121. As recalled, the digital task database 121 includes a plurality of digital tasks. For the purpose of explaining the training phase, reference will be made to one or more “training digital tasks” that are stored within the digital task database 121. It should be expressly understood that these training digital tasks need not be different from the digital tasks explained previously with reference to FIG. 2. In other words, the training digital tasks may be stored within the digital task database 121 using the same manner as described above.

For the purpose of illustration, it should be assumed that the digital task database 121 includes a training digital task 302 which is transmitted, by the crowdsourcing application 118 to a set of human assessors 106, the set of human assessors 106 including a first human assessor 304, a second human assessor 306 and a third human assessor 308. Needless to say, it is contemplated that the training digital task 302 be transmitted to more or fewer than 3 human assessors.

In response to receiving the training digital task 302, each of the first human assessor 304, the second human assessor 306 and the third human assessor 308 executes the training digital task 302 by selecting a label. For example, the MLA 126 is configured to receive a set of responses 310 comprising, a first training label 312 assigned by the first human assessor 304, a second training label 314 received by the second human assessor 306 and a third training label 316 received by the third human assessor 308. It is noted that the MLA 126 is configured to receive the set of responses 310 including raw (i.e. non-aggregated) first training label 312, the second training label 314 and the third training label 316.

In some non-limiting embodiments of the present technology, the training digital task 302 is further inputted into the MLA 126 to generate a task vector representation 318 of the training digital task 302. In some non-limiting embodiments of the present technology, MLA 126 is configured to determine, or receive from the digital task database 121, the one or more latent features associated with the training digital task 302 and generate the task vector representation 318 based on the one or more latent features associated with the training digital task 302. How the task vector representation 318 is generated based on the one or more latent features associated with the training digital task 302 is not limited, and may include, without limitation, via the use of long short-term memory (LSTM) based algorithm, BERT based algorithm, and convolutional neural network (CNN) based algorithm and the like.

In some non-limiting embodiments of the present technology, the MLA 126 is further configured to receive the worker activity history, from the log database 124, for each of the human assessors included within the set of human assessors 106. The MLA 126 is then configured to generate a set of worker vector representations 320, comprising a first worker vector representation 322 associated with the first human assessor 304, a second worker vector representation 324 associated with the second human assessor 306 and a third worker vector representation 326 associated with the third human assessor 308. How the set of worker vector representations 320 are generated is not limited, and may include, without limitation, via the use of long short-term memory (LSTM) based algorithm, BERT based algorithm, and convolutional neural network (CNN) based algorithm and the like.

In some non-limiting embodiments of the present technology, the MLA 126 is configured to determine, for a given human assessor, a latent parameter indicative of a degree of bias of the given human assessor towards one or more latent features. How the latent parameter is being determined is not limited. Recalling that a given worker activity history includes (i) the indication of all task IDs previously completed, and (ii) the indication of the task IDs for which the labels previously chosen by associated human assessor 106 were determined to be a true label for the respective digital task, the MLA 126 is configured to determine the latent parameter by an analysis of a confusion matrix of the associated human assessor, using, in some non-limiting embodiments of the present technology, a CoNAL-based method. More specifically, the MLA 126 is configured to determine, for the given human assessor, the latent parameter by analyzing the effect of the one or more set of latent features onto the response of the given human assessor 106. Needless to say, other means for determining the latent parameter is contemplated, such as via the use of a Dawid-Skene model, GLAD model and M-MSR model. In some non-limiting embodiments of the present technology, the MLA 126 is configured to generate the set of worker vector representations 320 based on the one or more latent features of the first human assessor 304, the second human assessor 306 and the third human assessor 308.

How the set of worker vector representations 320 are generated is not limited. In some non-limiting embodiments of the present technology, a given worker vector representation (such as the first worker vector representation 322) is generated as a random vector (not shown) of a random length. During the training phase, the first random vector is concatenated with a previous task vector representation associated with a previously completed digital task by the given worker, thereby generating a concatenated vector. A backpropagation technique is then used in order to amend the first random vector and the previous task vector representation, the backpropagation being done based on the label selected by the given worker for the previously completed digital task.

Needless to say, although only one training digital task (i.e. the training digital task 302) and three human assessors (i.e. the first human assessor 304, the second human assessor 306 and the third human assessor 308) have been illustrated, it is merely done for ease of illustration and it is contemplated the more than one training digital task may be transmitted to more than three human assessors.

The set of responses 310, the task vector representation 318, and the set of worker vector representations 320 together form a set of training data 328 (described in more detail below).

How the MLA 126 is trained using the set of training data 328 will now be explained. The set of training data 328 comprises triplets of training data, namely a first triplet of training objects 330, a second triplet of training objects 332, and a third triplet of training objects 334. In some non-limiting embodiments of the present technology, each triplet of training objects is associated with a given human assessor and the training digital task. For example, the first triplet of training objects 330 is associated with the first human assessor 304 and comprises the first training label 312, the task vector representation 318 and the first worker vector representation 322.

The set of training data 328, or more specifically, the individual triplets of training objects are inputted into the MLA 126. The MLA 126 includes a training logic to determine a set of features associated within each triplet of training objects (ex. the first training label 312, the task vector representation 318 and the first worker vector representation 322). Based on the set of features associated with each triplets of training objects, the MLA 126 is configured to learn to predict a label for a given digital task, based on the given digital task's task vector representation and a given worker vector representation. More specifically, during the in-use phase (described in detail below), the MLA 126 is configured to produce a probability distribution on the label of a given digital task likely to be selected by a given human assessor, provided the given human assessor's worker vector representation and the given digital task's task representation vector (described in detail below).

Needless to say, although there is only depicted a single instance of the training of the MLA 126, it is done so for ease of illustration. It should be expressly understood that the training of the MLA 126 is done iteratively using a plurality of different triplets of training objects.

### MLA 126—In Use

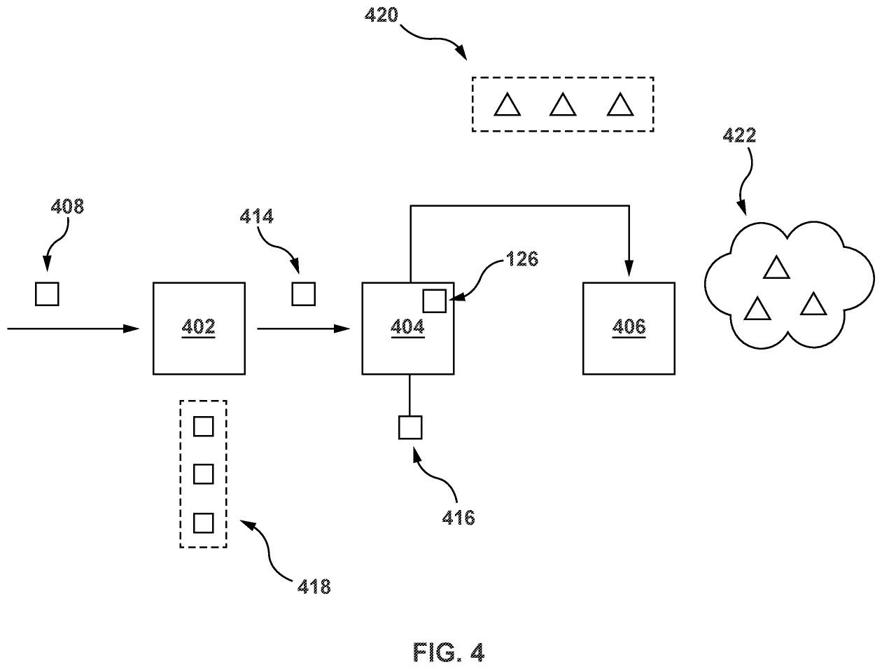

Now, having described the manner in which the MLA 126 has been trained prior to the in-use phase, attention will now be turned to FIG. 4, illustrating a schematic illustration of the operation of the crowdsourcing application 118, configured to execute the MLA 126 (see FIG. 1). The crowdsourcing application 118 execute (or otherwise has access to): a receiving routine 402, a selection routine 404 and an aggregation routine 406.

In the context of the present specification, the term “routine” refers to a subset of the computer executable program instructions of the crowdsourcing application 118 that is executable by the processor 116 to perform the functions explained below in association with the various routines (the receiving routine 402, the selection routine 404 and the aggregation routine 406). For the avoidance of any doubt, it should be expressly understood that the receiving routine 402, the selection routine 404 and the aggregation routine 406 are illustrated schematically herein as separate entities for ease of explanation of the processes executed by the crowdsourcing application 118. It is contemplated that some or all of the receiving routine 402, the selection routine 404 and the aggregation routine 406 may be implemented as one or more combined routines. Moreover, it is contemplated that some of the receiving routine 402, the selection routine 404 and the aggregation routine 406 be executed by an application (not shown) communicatively coupled to the crowdsourcing application 118, the application being stored within the server 102 or another entity.

For ease of understanding the present technology, functionality of each one of the receiving routine 402, the selection routine 404 and the aggregation routine 406, as well as data and/or information processed or stored therein are described below.

### Receiving Routine 402

The receiving routine 402 is configured to receive a data packet 408 from the digital task database 121. The data packet comprises a digital task to be completed by the one or more human assessors 106. For the purpose of the explanation, let us assume that the data packet 408 comprises the digital task 208. Needless to say, although a single data packet 408 is shown, this is merely for ease of understanding, and it should be understood that a plurality of data packets each containing a given digital task may be received by the receiving routine 402.

In some non-limiting embodiments of the present technology, the receiving routine 402 is configured to analyze the set of task features of the digital task 208 by accessing the digital task database 121. More specifically, the receiving routine 402 is configured to determine the type and inherent difficulty of the digital task 208.

In some non-limiting embodiments of the present technology, the receiving routine 402 is further configured to access the log database 124 and select one or more worker activity histories meeting a predetermined condition. In some non-limiting embodiments of the present technology, the predetermined condition corresponds to selecting one or more worker activity histories having the quality score above a predetermined threshold. In additional non-limiting embodiments of the present technology, the predetermined condition corresponds to N-number of worker activity histories having a quality score above a predetermined threshold for similar and inherent complexity to the type of the digital task 208. More specifically, recalling that the digital task 208 is a classification digital task, the receiving routine 402 is configured to select one or more worker activity histories having the quality score for classification digital tasks with similar difficulty (to the digital task 208), above the predetermined threshold. How the predetermined threshold is determined is not limited, and may for example be determined by an administrator of the crowdsourcing application 118.

Let us assume that the receiving routine 402 has identified 3 worker activity histories that meet the predetermined condition. The receiving routine 402 is then configured to generate a set of worker vector representations 418, each of the worker vector representation corresponding to a vectorial representation of a given worker activity history meeting the predetermined condition. Although only 3 worker activity histories have been explained as having met the predetermined condition, this is merely done for ease of illustration and it should be understood that more or less than 3 worker activity histories may meet the predetermined condition.

The receiving routine 402 is further configured to transmit a data packet 414 to the selection routine 404. The data packet 414 comprises the digital task 208 and the set of worker vector representations 418.

### Selection Routine 404

In response to receiving the data packet 414, the selection routine 404 is configured to execute the following functions.

Firstly, the selection routine 404 is configured to generate a task vector representation 416 of the digital task 208 using the MLA 126.

Having generated the task vector representation 416 and having the set of worker vector representations 418, the selection routine 404 is configured to execute the MLA 126, previously trained to predict a label (i.e. the first label 210 or the second label 212) based on the task vector representation 416 and the each of the worker vector representation included within the set of worker vector representations 418. Recalling that the set of worker vector representations 418 includes 3 worker vector representations, the MLA 126 is configured to generate a first set of selected labels 420 (each individual selected result/label by the MLA 126 being illustrated as a triangle) and transmit the set of selected labels 420 to the aggregation routine 406.

### Aggregation Routine 406

The first set of selected labels 420 form a total set of selected labels 422.

In some non-limiting embodiments of the present technology, the aggregation routine 406 is configured to select from the total set of selected labels 422, a “true” or “correct” label to the digital task 208. How the correct label is determined is not limited. In some non-limiting embodiments of the present technology, the correct label corresponds to the label having a majority vote within the total set of selected labels 422. In some non-limiting embodiments of the present technology, it is contemplated that it possible to determine the “true” or “correct” label using a weighted majority vote. How the weighted majority vote is implemented is known in the art and may be based on a GLAD-algorithm or Dawid-Skene algorithm.

Let us assume for example, that within the total set of selected labels 422, the first label 210 has been selected twice, and the second label 212 has been selected once, the aggregation routine 406 is configured to select the first label 210 as the correct label to the digital task 208.

Although in the above explanation, the total set of selected labels 422 comprises only the first set of selected labels 420 (received by the MLA 126), it is not limited as such.

In some non-limiting embodiments of the present technology it is contemplated that the total set of selected labels 422 also includes a second set of selected labels (not shown) received by one or more human assessors 106. More specifically, in some non-limiting embodiments of the present technology, the receiving routine 402 is further configured to transmit the data packet 408 to one or more human assessors 106, that select one or more labels forming the second set of labels that are transferred to the aggregation routine 406. In such instance, the total set of selected labels 422 comprises both the first set of selected labels 420 (received by the MLA 126) and the second set of labels (received by the human assessors 106). In some non-limiting embodiments of the present technology, the 3 worker activity histories that meet the predetermined condition as selected by the selection routine 404 is not associated with the one or more human assessors 106 which have received the data packet 408 and submitted a label included in the second set of selected labels. In some non-limiting embodiments of the present technology, the aggregation routine 406 is further configured to calculate and issue rewards to the human assessors 106 who has selected the correct label, i.e. the first label 210.

In some non-limiting embodiments of the present technology, the aggregation routine 406 is further configured to access the log database 124 (see FIG. 1) and update the quality scores of the human assessors 106 who have submitted the first set of selected labels 412.

The various non-limiting embodiments of the present technology may allow the selection of a label for a digital task using the MLA 126, with or without the need of labels received by one or more human assessors 106.

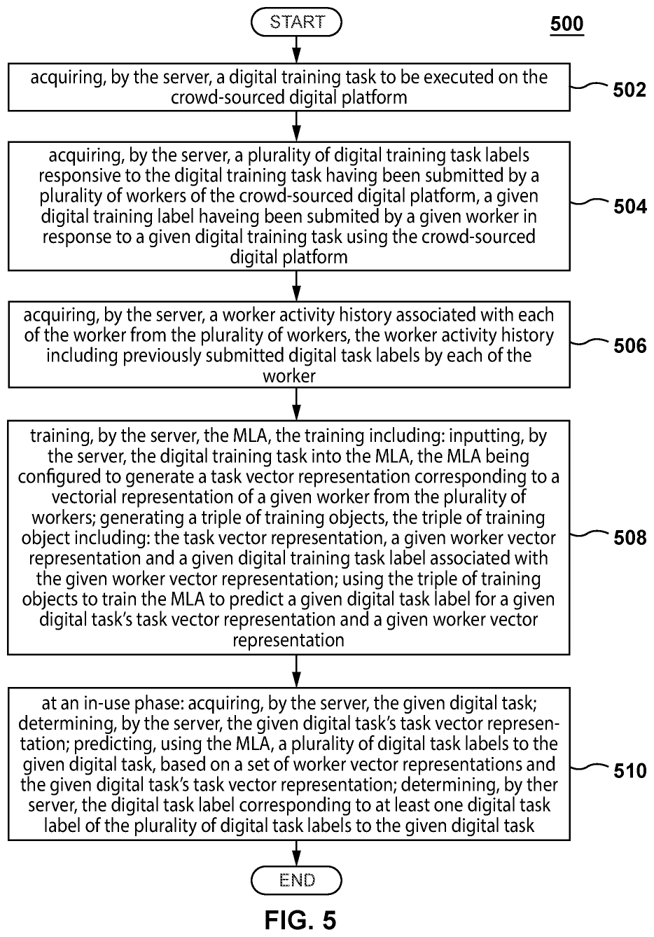

Given the architecture and examples provided herein above, it is possible to execute a computer-implemented method for generating a digital task label by a machine learning algorithm in a crowdsourced digital platform. With reference to FIG. 5, there is provided a flow chart of a method 500, the method 500 being executable in accordance with non-limiting embodiments of the present technology. The method 500 may by executed by the server 102 or a different entity (such as a server) communicatively coupled to the server 102.

Step 502: Acquiring, by the Server, a Digital Training Task to be Executed on the Crowdsourced Digital Platform

The method 500 starts at step 502, where the training digital task 302 is transmitted, by the crowdsourcing application 118 to a set of human assessors 106.

Step 504: Acquiring, by the Server, a Plurality of Digital Training Task Labels Responsive to the Digital Training Task Having been Submitted by a Plurality of Workers of the Crowdsourced Digital Platform, a Given Digital Training Label Having been Submitted by a Given Worker in Response to a Given Digital Training Task Using the Crowdsourced Digital Platform

At step 504, in response to response to receiving the training digital task 302, each of the first human assessor 304, the second human assessor 306 and the third human assessor 308 executes the training digital task 302 by selecting a label. For example, the MLA 126 is configured to receive a set of responses 310 comprising, a first training label 312 assigned by the first human assessor 304, a second training label 314 received by the second human assessor 306 and a third training label 316 received by the third human assessor 308. It is noted that the MLA 126 is configured to receive the set of responses 310 including raw (i.e. non-aggregated) first training label 312, the second training label 314 and the third training label 316.

Step 506: Acquiring, by the Server, a Worker Activity History Associated with Each of the Worker from the Plurality of Workers, the Worker Activity History Including Previously Submitted Digital Task Labels by Each of the Worker

At step 506, the MLA 126 or the server 102 is configured to receive the worker activity history, from the log database 124, for each of the human assessors included within the set of human assessors 106.

Step 508: Training, by the Server, the MLA, the Training Including: Inputting, by the Server, the Digital Training Task into the MLA, the MLA being Configured to Generate a Task Vector Representation Corresponding to a Vectorial Representation of the Digital Training Task; Inputting, by the Server, the Worker Activity Histories into the MLA, the MLA being Configured to Generate a Respective Worker Vector Representation Corresponding to a Vectorial Representation of a Given Worker Activity History for a Given Worker from the Plurality of Workers; Generating a Triplet of Training Objects, the Triplet of Training Object Including: The Task Vector Representation, a Given Worker Vector Representation and a Given Digital Training Task Label Associated with the Given Worker Vector Representation; Using the Triplet of Training Objects to Train the MLA to Predict a Given Digital Task Label for a Given Digital Task's Task Vector Representation and a Given Worker Vector Representation

At step 508, the MLA 126 is configured to generate a set of worker vector representations 320, comprising a first worker vector representation 322 associated with the first human assessor 304, a second worker vector representation 324 associated with the second human assessor 306 and a third worker vector representation 326 associated with the third human assessor 308.

The MLA 126 is further configured to receive, as input, the training digital task 302 and generate a task vector representation 318 of the training digital task 302. In some non-limiting embodiments of the present technology, MLA 126 is configured to determine, or receive from the digital task database 121, the one or more latent features associated with the training digital task 302 and generate the task vector representation 318 based on the one or more latent features associated with the training digital task 302.

The set of responses 310, the task vector representation 318, and the set of worker vector representations 320 together form a set of training data 328 (described in more detail below).

How the MLA 126 is trained using the set of training data 328 will now be explained. The set of training data 328 comprises triplets of training data, namely a first triplet of training objects 330, a second triplet of training objects 332, and a third triplet of training objects 334. In some non-limiting embodiments of the present technology, each triplet of training objects is associated with a given human assessor and the training digital task. For example, the first triplet of training objects 330 is associated with the first human assessor 304 and comprises the first training label 312, the task vector representation 318 and the first worker vector representation 322.

The set of training data 328, or more specifically, the individual triplets of training objects are inputted into the MLA 126. The MLA 126 includes a training logic to determine a set of features associated within each triplet of training objects (ex. the first training label 312, the task vector representation 318 and the first worker vector representation 322). Based on the set of features associated with each triplets of training objects, the MLA 126 is configured to learn to predict a label for a given digital task, based on the given digital task's task vector representation and a given worker vector representation.

Step 510: At an In-Use Phase: Acquiring, by the Server, the Given Digital Task; Determining, by the Server, the Given Digital Task's Task Vector Representation; Predicting, Using the MLA, a Plurality of Digital Task Labels to the Given Digital Task, Based on a Set of Worker Vector Representations and the Given Digital Task's Task Vector Representation; Determining, by the Server, the Digital Task Label Corresponding to at Least One Digital Task Label of the Plurality of Digital Task Labels to the Given Digital Task.

At step 510, the server 102 receives the data packet 408 comprising the digital task 208 from the digital task database 121. The server 102 is configured to access the log database 124 and select one or more worker activity histories meeting a predetermined condition. Let us assume that the sever 102 has identified 3 worker activity histories that meet the predetermined condition. The server 102 is then configured to generate a set of worker vector representations 418, each of the worker vector representation corresponding to a vectorial representation of a given worker activity history meeting the predetermined condition. The server 102 is further configured to generate a task vector representation 416 of the digital task 208 using the MLA 126.

Having generated the task vector representation 416 and having the set of worker vector representations 418, the server 102 is configured to execute the MLA 126, previously trained to predict a label (i.e. the first label 210 or the second label 212) based on the task vector representation 416 and the each of the worker vector representation included within the set of worker vector representations 418.

The method 500 then terminates.

It should be apparent to those skilled in the art that at least some embodiments of the present technology aim to expand a range of technical solutions for addressing a particular technical problem encountered by the conventional crowdsourced technology, namely determining a result to a task within the crowdsourced environment.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or reordered without departing from the teachings of the present technology. Accordingly, the order and grouping of the steps is not a limitation of the present technology.

1. A computer-implemented method for generating a digital task label by a machine learning algorithm (MLA), the method being executable by a server communicatively coupled to a crowdsourced digital platform, the method comprising:
at a training phase:
acquiring, by the server, a digital training task to be executed on the crowdsourced digital platform;
acquiring, by the server, a plurality of digital training task labels responsive to the digital training task having been submitted by a plurality of workers of the crowdsourced digital platform, a given digital training label having been submitted by a given worker in response to a given digital training task using the crowdsourced digital platform;
acquiring, by the server, a worker activity history associated with each of the worker from the plurality of workers, the worker activity history including previously submitted digital task labels by each of the worker;
training, by the server, the MLA, the training including:
inputting, by the server, the digital training task into the MLA, the MLA being configured to generate a task vector representation corresponding to a vectorial representation of the digital training task;
inputting, by the server, the worker activity histories into the MLA, the MLA being configured to generate a respective worker vector representation corresponding to a vectorial representation of a given worker activity history for a given worker from the plurality of workers;
generating a triplet of training objects, the triplet of training object including: the task vector representation, a given worker vector representation and a given digital training task label associated with the given worker vector representation;
using the triplet of training objects to train the MLA to predict a given digital task label for a given digital task's task vector representation and a given worker vector representation;
at an in-use phase:
acquiring, by the server, the given digital task;
determining, by the server, the given digital task's task vector representation;
predicting, using the MLA, a plurality of digital task labels to the given digital task, based on a set of worker vector representations and the given digital task's task vector representation;
determining, by the server, the digital task label corresponding to at least one digital task label of the plurality of digital task labels to the given digital task.

2. The method of claim 1, wherein determining the digital task label comprises executing a majority vote of the plurality of digital task labels to the given digital task.

3. The method of claim 1, wherein the method further comprises determining for each of the worker of the plurality of workers, a respective quality score corresponding to a previous success rate in providing correct digital task labels, the previous success rate being determined based on the respective worker activity history.

4. The method of claim 3, wherein the set of worker vector representations comprises a subset of the plurality of workers meeting a predetermined condition.

5. The method of claim 4, wherein the predetermined condition corresponds to the subset of the plurality of workers comprising one or more workers having a previous success rate above a predetermined threshold.

6. The method of claim 3, wherein the given digital task is a first type of digital task, and the predetermined condition corresponds to the subset of the plurality of workers comprising one or more workers having a previous success rate above a predetermined threshold for the first type of digital task.

7. The method of claim 1, wherein generating the worker vector representation for the given worker comprises:
determining, for the given worker, a latent parameter indicative of a degree of bias of the given worker towards one or more latent features included within the digital training task, the latent parameter being determined by an analysis of a confusion matrix associated with the given worker;
generating the worker representation based on the latent parameter.

8. The method of claim 7, wherein generating the task vector representation of the training digital task comprises:
determining, for the training digital task, one or more latent features affecting the selection of the given training label by the given worker;
generating the task vector representation based on the one or more latent features.

9. The method of claim 8, wherein the one or more latent features include at least one of:
a font size associated with the content of the training digital task;
an image size associated with the content of the training digital task;
a number of possible selectable labels associated with the training digital task;
a location of the possible selectable labels within the content of the training digital task.

10. A system for generating a digital task label by a machine learning algorithm (MLA), the system comprising a server communicatively coupled to a crowdsourced digital platform, the server comprising a processor configured to:
at a training phase:
acquire, a digital training task to be executed on the crowdsourced digital platform;
acquire, a plurality of digital training task labels responsive to the digital training task having been submitted by a plurality of workers of the crowdsourced digital platform, a given digital training label having been submitted by a given worker in response to a given digital training task using the crowdsourced digital platform;
acquire, a worker activity history associated with each of the worker from the plurality of workers, the worker activity history including previously submitted digital task labels by each of the worker;
train, the MLA, to train the MLA, the processor being configured to:
input, the digital training task into the MLA, the MLA being configured to generate a task vector representation corresponding to a vectorial representation of the digital training task;
input, the worker activity histories into the MLA, the MLA being configured to generate a respective worker vector representation corresponding to a vectorial representation of a given worker activity history for a given worker from the plurality of workers;
generate a triplet of training objects, the triplet of training object including: the task vector representation, a given worker vector representation and a given digital training task label associated with the given worker vector representation;
use the triplet of training objects to train the MLA to predict a given digital task label for a given digital task's task vector representation and a given worker vector representation;
at an in-use phase:
acquire, the given digital task;
determine, the given digital task's task vector representation;
predict, by executing the MLA, a plurality of digital task labels to the given digital task, based on a set of worker vector representations and the given digital task's task vector representation;
determine, the digital task label corresponding to at least one digital task label of the plurality of digital task labels to the given digital task.

11. The system of claim 10, wherein to determine the digital task label, the processor is configured to execute a majority vote of the plurality of digital task labels to the given digital task.

12. The system of claim 10, wherein the processor is further configured to determine for each of the worker of the plurality of workers, a respective quality score corresponding to a previous success rate in providing correct digital task labels, the previous success rate being determined based on the respective worker activity history.

13. The system of claim 12, wherein the set of worker vector representations comprises a subset of the plurality of workers meeting a predetermined condition.

14. The system of claim 13, wherein the predetermined condition corresponds to the subset of the plurality of workers comprising one or more workers having a previous success rate above a predetermined threshold.

15. The system of claim 12, wherein the given digital task is a first type of digital task, and the predetermined condition corresponds to the subset of the plurality of workers comprising one or more workers having a previous success rate above a predetermined threshold for the first type of digital task.

16. The system of claim 10, wherein to generate the worker vector representation for the given worker, the processor is configured to:
determine, for the given worker, a latent parameter indicative of a degree of bias of the given worker towards one or more latent features included within the digital training task, the latent parameter being determined by an analysis of a confusion matrix associated with the given worker;
generate the worker representation based on the latent parameter.

17. The method of claim 16, wherein to generate the task vector representation of the training digital task, the processor is configured to:
determine, for the training digital task, one or more latent features affecting the selection of the given training label by the given worker;
generate the task vector representation based on the one or more latent features.

18. The method of claim 17, wherein the one or more latent features include at least one of:
a font size associated with the content of the training digital task;
an image size associated with the content of the training digital task;
a number of possible selectable labels associated with the training digital task;
a location of the possible selectable labels within the content of the training digital task.
